(19) United States
(12) Patent Application Publication
(10) Pub. No.: US 2009/0056199 A1
(43) Pub. Date: Mar. 5, 2009

(54) Integral Rivets Formed Of An Adhesive For Fastening Rodenticide Bait Stations To A Substrate And Ballasted Bait Station

(76) Inventor: Michael E. Reed, Lakeland, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 12/187,300

(22) Filed: Aug. 6, 2008

Related U.S. Application Data
(60) Provisional application No. 60/954,305, filed on Aug. 6, 2007.

(51) Int. Cl. A01M 25/00; B32B 37/00; B32B 3/06

(52) U.S. Cl. 43/131; 156/295; 428/99

(57) ABSTRACT

A rivet formed of an adhesive to form a mechanical attachment to a bait station which is then adhered by the adhesive to a substrate at the intended location of use. In another embodiment, adhesive rivet is also mechanically attached to the substrate. The invention also comprises a ballasted bait station of a sufficient weight to immobilize the bait station. The ballasted bait station may then simply be placed in the intended location.

### CROSS-REFERENCE TO RELATED APPLICATIONS

This application claims the benefit of provisional patent application 60/954,305, filed Aug. 6, 2007, the disclosure of which is hereby incorporated by reference herein.

### BACKGROUND OF THE INVENTION

1. Field of the Invention

This invention relates to rodenticide bait stations. More particularly, this invention relates to integral rivets formed of an adhesive for fastening bait stations to a substrate. This invention also relates to bait stations that are ballasted to prevent movement when placed on a substrate.

2. Description of the Background Art

Presently there exist numerous types of bait stations designed to be placed on a substrate, such as a floor or in an attic, to distribute poison bait to control small animal pests, especially rodents.

EPA Pesticide Registration Notice 94-7 requires that bait stations be locked and immobilized to resist efforts to gain access to the rodenticide therein and to preclude dislodgment of the bait station once placed in its intended location.

In compliance with the Notice 94-7, conventional bait stations are anchored at the intended location in a number of ways depending upon the substrate. Intended locations inside a building may comprise, for example, living areas, basements and attics whereas other locations may be outside the perimeter of the building. The substrates may comprise the floor of the living area, basement or attic, a concrete pad or sidewalk of a perimeter of the building.

For intended locations that do not have a suitable substrate to which the bait station may be anchored, the bait station may be anchored to a separate substrate, such as concrete pad (e.g., 12″×12″), of sufficient weight to provide adequate immobilization when placed in the intended location. Alternatively, the bait stations may be ballasted with sufficient weight to provide adequate immobilization.

Common anchors for affixing the bait stations to substrates comprise stakes, chains, nails, screws and adhesives (e.g., ™“Liquid Nails”). More particularly, in the case of an adhesive anchor, an amount of the adhesive is applied to the underside of the bait station and then mounted onto the substrate. Upon curing of the adhesive, the bait station is adhered to the substrate.

The following United States patents, the disclosures of each of which are hereby incorporated by reference herein, disclose typical bait stations and related devices:

| PATENT | Title |
|---|---|
| 7,377,072 | Bait station |
| 7,310,908 | Insect bait station |
| 7,204,054 | Insecticidal activatable bait station |
| 7,165,353 | Insect suppression station |
| 7,067,142 | Packaged rodenticide |
| 7,051,473 | Bait device |
| 7,043,873 | Insect dual bait station |
| 6,807,768 | Bait station with screw-off child- |
| | resistant lid |
| 6,792,713 | Replenishable pest control apparatus |
| 6,671,999 | Insect and rodent bait station |
| 6,513,283 | Weight for rodent bait stations |
| 6,493,988 | Bait station with internal card holder |
| 6,415,544 | Rodent trap with entrapping teeth |
| 6,397,517 | Bait station with interior mechanical |
| | rodent trap |
| 6,389,738 | Alternating rodent insect trap |
| 5,448,852 | Reinforced rodent bait station |
| 5,446,992 | Vermin bait station |
| 5,044,113 | Multi-edged rodent bait |
| 5,040,327 | Polygonal bait station |
| 4,926,581 | Animal trap |
| 4,619,071 | Rodent bait station |
| 4,486,973 | Shellfish traps |
| 4,468,883 | Mouse trap |
| 4,453,337 | Rodent feed station |
| 4,031,653 | Baiting arrangement for rodents |
| 2,683,326 | Rodent exterminating device |
| D564,794 | Bait station box |
| D544,064 | Bait station |
| D537,903 | Bait station |
| D531,257 | Bait station |
| D515,175 | Bait station |
| D357,969 | Combined bait holder and weight |

Unfortunately, however, adhesive anchoring devices have been marginally successful as an adequate anchoring means due to the material composition of the bait station, typically polypropylene, which inhibits the adequate adherence of the adhesive due to the high surface tension of polypropylene. Consequently, adhesive anchoring devices employed with polypropylene bait stations may fail prematurely.

Further, adhesive anchoring devices may become brittle and break, losing their adhering bond. Since bait stations are typically serviced infrequently (e.g., monthly), a bait station may become dislodged (i.e., un-affixed) from its substrate several weeks for its next servicing, and potentially leak its rodenticide into the environment.

Therefore, it is an object of this invention to provide an improvement which overcomes the aforementioned inadequacies of the prior art devices and provides an improvement which is a significant contribution to the advancement of the bait station art.

Another object of this invention is to provide a an apparatus and method for affixing a bait station to a substrate to immobilize the bait station.

Another object of the invention is to provide an apparatus and method for affixing a bait station to a substrate, comprising the step of forming an adhesive rivet between the substrate and an underside of a panel of the bait station and through a through-hole in the panel to form a head, whereby the adhesive rivet adheres to the substrate and is mechanically affixed to the panel.

Another object of the invention is to provide an adhesive rivet for affixing a bait station to a substrate, wherein the adhesive rivet is formed by applying the adhesive while in its liquid state to the underside of the panel about the through-hole formed through the panel; placing the bait station onto a substrate, whereupon a first portion of the still liquid adhesive flows onto the surface of the substrate and a second portion of the still-liquid adhesive flows through the through-hole in the panel; pushing the panel onto the substrate to force at least some of the first portion of the still-liquid adhesive through the through-hole to form a mushroom-shaped head onto an interior surface of the panel and to force at least some of the second portion of the liquid adhesive to spread out onto the substrate to form a greater contact area between the underside of the panel and the surface of the substrate; and upon curing of the adhesive, forming the adhesive rivet composed of some of the first portion of the adhesive that was forced through the through-hole to form the mushroom-shaped head on the inside surface of the panel and some of the second portion of the adhesive that was spread-out onto the surface of the substrate.

Another object of this invention is to provide an apparatus and method for ballasting a bait station to immobilize the bait station.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, in one embodiment, the invention comprises a rivet formed of an adhesive to form a mechanical attachment to a bait station which is then adhered by the adhesive to a substrate. In this manner, although the adhesive may not adequately adhere to the bait station (e.g., as in the case of a polypropylene bait station), a mechanical attachment with the bait station is nevertheless formed. The adhesive employed need only adhere to the intended substrate (wood, metal, concrete, and other bindables) upon which the bait station is to be mounted.

In another embodiment, the invention comprises a ballasted bait station of a sufficient weight to immobilize the bait station. The ballasted bait station may then simply be placed in the intended location.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIGS. 1A, 1B and 1C are partial cross-sectional views showing the process of forming the adhesive rivet of the invention to affix a bait station to a substrate;

FIGS. 2A, 2B and 2C are partial cross-sectional views showing the different embodiments of the form-cap of the invention to further define the formation of the head of the adhesive rivet;

FIG. 3 is a partial cross-sectional view showing the perforated dome that forms multiple heads of the adhesive rivet;

FIG. 4 is a partial cross-sectional view showing the formation of the rivet shaft in a mounting hole for mechanical affixation of the bait station to the substrate;

FIGS. 5A, 5B, 5C and 5D are partial cross-sectional views showing the different embodiments of the through-hole; and

FIG. 6A is a perspective view of the ballasted bait station of the invention; and

FIG. 6B is a partial cross-sectional view of FIG. 6A.

Similar reference characters refer to similar parts throughout the several views of the drawings.

### DETAILED DESCRIPTION OF THE PREFERRED EMBODIMENT

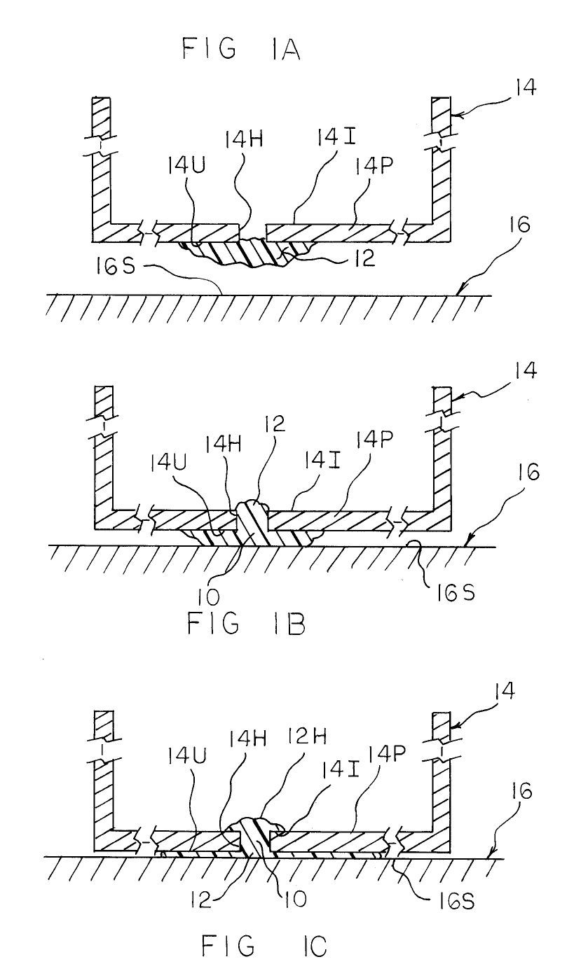

As shown in FIG. 1A, the adhesive rivet 10 of the invention is formed by applying a generous amount of an adhesive 12 while in its liquid state to the exterior underside 14U of a panel 14P of a bait station 14 about a through-hole 14H formed through the panel 14U of the bait station 14. As shown in FIG. 1B, when the bait station 14 is placed onto a substrate 16, one portion of the still liquid adhesive 12 flows onto the surface of the substrate 16S and another portion of the still-liquid adhesive 12 flows through the through-hole 14H in the panel 14U. As shown in FIG. 1C, further pushing of the bait station 14 onto the substrate 16, forces additional still-liquid adhesive 12 through the through-hole 14H to form a mushroom-shaped head 12H onto the interior surface 14I of the panel 14P of the bait station 14. Concurrently, the still-liquid adhesive 12 spreads out to form a greater contact area between the underside 14U of the panel 14P and the surface 16S of the substrate 16.

Upon curing of the adhesive 12, the portion of the adhesive 12 that was forced through the through-hole 14H to form the mushroom-shaped head 12H on the inside surface 14I of the panel 14P of the bait station 14, provides a secure mechanical attachment with the panel 14P of the bait station 14, whereas the remaining portion of the adhesive 12 on the underside 14U of the bait station 14 that adheres to the surface 16S of the substrate 16, provides an adhesive attachment to the substrate 16. Preferably, the adhesive qualities of the adhesive 12 also forms a seal with the through-hole 14H in the panel 14P to thereby preclude any leakage of the rodenticide therethrough.

It should be appreciated that upon curing of the adhesive, an integral adhesive rivet 10 is formed that creates a strong mechanic attachment to the bait station 14 due to its mushroom-shaped head 12H that encircles the interior periphery of the through-hole 14H in the panel 14. Consequently, despite the fact that the adhesive 12 may not adequately adhere to the bait station 14 (e.g., as in the case of a polypropylene bait station), a mechanical attachment with the bait station 14 is nevertheless formed. The adhesive characteristics of the adhesive 12 therefore need only be such as to adhere to the intended substrate 16 (wood, metal, concrete, and other bindables) upon which the bait station 14 is to be mounted. Preferably, the adhesive 12 comprises a high modulus adhesive for exterior bonding and forming.

More preferably, the adhesive 12 comprises a 100% solids two-part fastener adhesive that is thixotropic, having at least a tensile strength exceeding 4,000 psi, and at least a 40% elongation that can be formed into the adhesive rivet 10, dispensed manually, mechanically or pneumatically, and has a work time of 10-180 seconds. Still more preferably, the adhesive 12 does not emit an odor to distract rodents from otherwise entering the bait station 14 nor is it tastefully edible by such rodents. Finally, the adhesive 12 also preferably does degrade due to the environment of the intended location of the bait station 14.

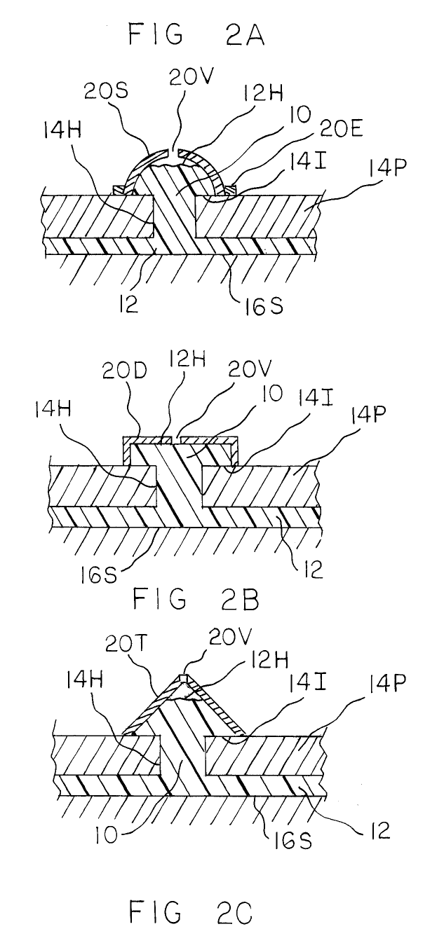

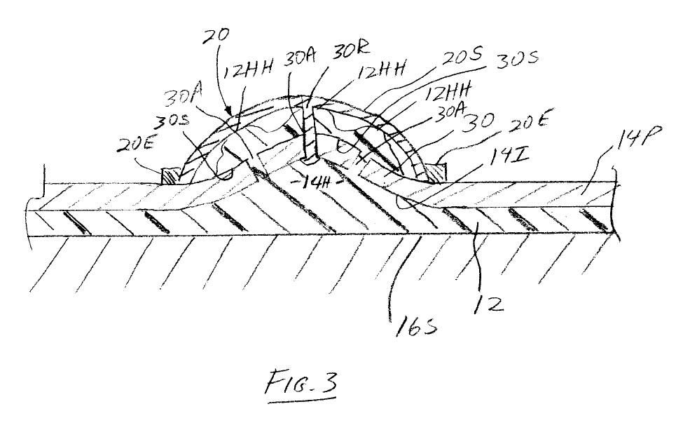

As shown in FIG. 2A, in another embodiment of the invention, a form-cap 20 may be positioned over the through-hole 14H in the bait station to control the thickness and girth of the mushroom-shaped head 12H of the adhesive rivet 10 that forms on the interior surface 14I of the panel 14P of the bait station 14. The form-cap 20 may be vented via vent 20V to preclude an air-block that might otherwise impede the flow of the still-liquid adhesive 12 therein during formation of the mushroom-shaped head 12H.

As shown in FIG. 2A, preferably, the form-cap 20 comprises a semi-spherical configuration 20S. However, as shown in FIGS. 2B and 2C, respectively, other three-dimensional configurations may be employed such as a disk-shaped configuration 20D (similar to a washer) and a triangular-shaped configuration 20T.

As shown in FIG. 2A, the form-cap 20 may snap-fit into a retainer 20E that is formed about the through-hole 14H (e.g., during injection molding or vacuum forming of the panel 14P). Alternatively, the form-cap may be staked to the panel 14P or separately affixed to the panel 14P about the through-hole (e.g., by an adhesive, sonic welding, etc.). Further alternatively, the form-cap 20 itself may be formed integrally about the through-hole 14H of the panel 14P of the bait station 14 (e.g., during injection molding or vacuum forming of the panel 14P).

As shown in FIG. 3, in another embodiment of the invention, a perforated dome 30 may be formed about the through-hole 14H in the panel 14P of the bait station 14 to initially begin defining the mushroom-shaped head 12H of the adhesive rivet 10 and to further increase the mechanical connection with the panel 14P of the bait station 14 as the still-liquid adhesive 12 flows through the apertures 30A of the dome 30 onto the surface 30S of the dome 30 to form multiple mushroom-shaped heads 12HH thereon. Preferably, as shown, the dome 30 is formed integrally about the through-hole 14H of the panel 14P of the bait station 14 (e.g., during injection molding or vacuum forming of the panel 14P). However, it should be appreciated that the dome 30 may be separately affixed about the through-hole 14H by staking or with an adhesive, sonic welding, or the like.

If used in conjunction with the form-cap 20, the subsequently-installed form-cap 20 would further define the multiple mushroom-shaped heads 30HH on the surface of the dome 30 that provide a multiple secure mechanical affixations with the panel 14P of the bait station 14. Preferably, a center retainer 30R that snaps into the dome's center aperture 30A to hold the form-cap 20 in position while the adhesive 12 cures.

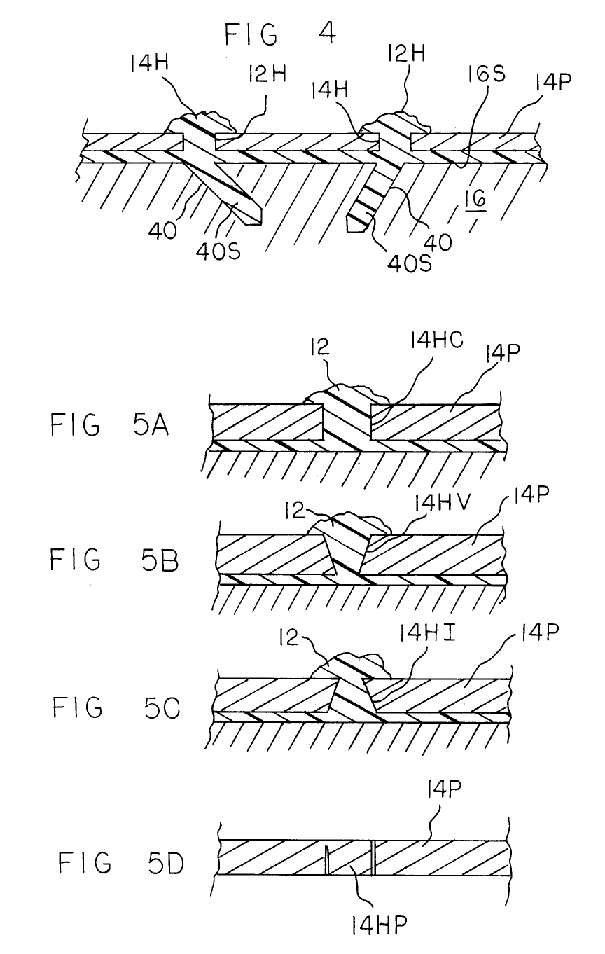

As shown in FIG. 4, in another embodiment of the invention, in addition to or in lieu of the form-cap 20 and/or dome 30, the panel 14P of the bait station 14 may also be mechanically mounted to the substrate 16. More specifically, a mounting hole 40 may be drilled into the substrate 16 in alignment with the through-hole 12H in the panel 14P of the bait station 14. In this manner, when the bait station 14 with adhesive 12 applied about its through-hole 14H is positioned onto the substrate 16, the adhesive 12 may flow into the mounting hole 40 to form, when cured, a rivet shaft 40S. The rivet shaft 40S positioned in the mounting hole 40 provides, in addition to its adhesive affixation, further mechanical mounting of the panel 14P of the bait station 14 to the substrate 16.

It is noted that additional adhesive 12 may be pre-applied into the mounting hole 40 to pre-fill the mounting hole 40 before the bait station 14 is positioned onto the substrate 16. It is also noted that the mounting hole 40 may be angularly drilled in the substrate 16, with its top in alignment with the through-hole 14H in the panel 14P, such that the adhesive 12 flows into the mounting hole 40 and forms an angled rivet shaft 40S extending into the substrate itself. Opposing mounting holes 40 may be angled in different directions (e.g., toward or away from each other) to further enhance the mechanical mounting of the bait station 14.

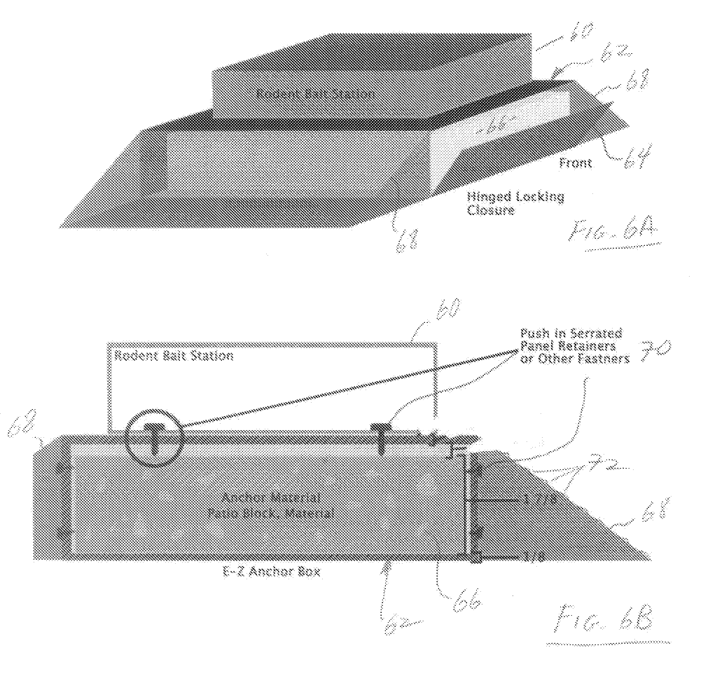

As shown in FIGS. 5A, B, and C, respectively, the through-hole 14H may be formed having a circular-cylindrical configuration 14HC, a V-configuration 14HV or an inverted V-configuration 14HI to still further enhance the mechanical affixation of the adhesive rivet 12 to the panel 14P of the bait station 14 when cured therein. As shown in FIG. 5D, the through-hole 14H may be formed by a preformed knock-out plug 14HP that is simply knocked-out to form the through-hole 14H.

As shown in FIGS. 6A and 6B, in another embodiment of the invention, the invention comprises a ballasted bait station 60 including a locking chamber 62 with a snap-shut, pivotable access door 64 allowing a ballast 66, such as a concrete block, of sufficient weight to assure immobilization, to be inserted therein to thereby eliminate the need to otherwise secure the bait station 60 to a substrate 16. One or more side ramps 68 (e.g. two) may be affixed to the side panels of the chamber 62 by a plurality of serrated panel retainers 70 or other fasteners, thereby providing rodents easy ingress to the bait station 60. The side ramps 68 may be textured with horizontal ridges 72 to provide more traction to the rodents as they climb up the ramps 68.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method for affixing a bait station to a:
substrate, comprising the step of forming an adhesive rivet between the substrate and an underside of a panel of the bait station and through a through-hole in the panel to form a head, whereby the adhesive rivet adheres to the substrate and is mechanically affixed to the panel.

2. The method as set forth in claim 1, wherein the adhesive rivet forming step comprises applying the adhesive while in its liquid state to the underside of the panel about the through-hole formed through the panel;
placing the bait station onto a substrate, whereupon a first portion of the still liquid adhesive flows onto the surface of the substrate and a second portion of the still-liquid adhesive flows through the through-hole in the panel;
pushing the panel onto the substrate to force at least some of the first portion of the still-liquid adhesive through the through-hole to form a mushroom-shaped head onto an interior surface of the panel and to force at least some of the second portion of the liquid adhesive to spread out onto the substrate to form a greater contact area between the underside of the panel and the surface of the substrate; and
upon curing of the adhesive, forming the adhesive rivet composed of some of the first portion of the adhesive that was forced through the through-hole to form the mushroom-shaped head on the inside surface of the panel and some of the second portion of the adhesive that was spread-out onto the surface of the substrate.

3. The method as set forth in claim 2, wherein the adhesive qualities of the adhesive also forms a seal with the through-hole 14H in the panel 14P.

4. The method as set forth in claim 2, wherein the adhesive comprises a high modulus adhesive for exterior bonding and forming.

5. The method as set forth in claim 2, wherein the adhesive comprises a thixotropic adhesive.

6. The method as set forth in claim 5, wherein the adhesive has a tensile strength exceeding about 4,000 psi, and at least about 40% elongation.

7. The method as set forth in claim 2, wherein the adhesive does not emit an odor to distract rodents from otherwise entering the bait station.

8. The method as set forth in claim 2, wherein the adhesive is distasteful to rodents.

9. The method as set forth in claim 2, wherein the adhesive does degrade due to the environment of the intended location of the bait station.

10. The method as set forth in claim 2, further comprising the step of positioning a form-cap over the through-hole in the panel to control the thickness and girth of the mushroom-shaped head of the adhesive rivet that forms on the interior surface of the panel.

11. The method as set forth in claim 10, wherein the form-cap is vented to preclude an air-block that might otherwise impede the flow of the still-liquid adhesive therein during formation of the mushroom-shaped head.

12. The method as set forth in claim 11, wherein the form-cap comprises a semi-spherical configuration.

13. The method as set forth in claim 11, wherein the form-cap comprises a disk-shaped configuration.

14. The method as set forth in claim 11, wherein the form-cap comprises a triangular-shaped configuration.

15. The method as set forth in claim 11, wherein the form-cap comprises a rectangular-shaped configuration.

16. The method as set forth in claim 11, wherein the form-cap snap-fits into a retainer positioned about the through-hole.

17. The method as set forth in claim 11, wherein the form-cap is formed integrally about the through-hole of the panel

18. The method as set forth in claim 2, further comprising a perforated dome formed about the through-hole in the panel to initially begin defining the mushroom-shaped head of the adhesive rivet and to further increase the mechanical connection with the panel as the still-liquid adhesive flows through apertures in the dome onto the surface of the dome to form multiple mushroom-shaped heads thereon.

19. The method as set forth in claim 18, wherein the perforated dome is formed integrally about the through-hole.

20. The method as set forth in claim 10, further comprising a perforated dome formed about the through-hole in the panel to initially begin defining multiple mushroom-shaped heads of the adhesive rivet such that the still-liquid adhesive flows through apertures in the dome onto the surface of the dome to form multiple mushroom-shaped heads thereon.

21. The method as set forth in claim 20, wherein the subsequently-installed form-cap further defines the multiple mushroom-shaped heads on the surface of the dome.

22. The method as set forth in claim 21, wherein the form-cap includes a center retainer that snaps into one of the dome's apertures to hold the form-cap in position while the adhesive cures.

23. The method as set forth in claim 2, further including the step of mechanically connecting the adhesive rivet to the substrate.

24. The method as set forth in claim 23, wherein the step of mechanically connecting the adhesive rivet to the substrate comprises flowing the adhesive into a mounting hole in the substrate that is in alignment with the through-hole in the panel to thereby, when cured, form a rivet shaft therein.

25. The method as set forth in claim 24, wherein the mounting hole is positioned angularly in the substrate.

26. The method as set forth in claim 25, further including multiple adhesive rivets having rivet shafts angularly positioned in different directions.

27. The method as set forth in claim 2, wherein the through-hole comprises a circular-cylindrical configuration, a V-configuration or an inverted V-configuration.

28. The method as set forth in claim 2, wherein the through-hole is formed by a preformed knock-out plug that is knocked-out to form the through-hole.

29. An adhesive rivet for affixing a bait station to a substrate, comprising in combination:
a first portion of an adhesive positioned through a through-hole in a panel of the bait station with a head thereof positioned on the interior of the through-hole; and
a second portion of the adhesive between positioned the substrate and an underside of a panel;
whereby the adhesive rivet adheres to the substrate and is mechanically affixed to the panel.

30. The adhesive rivet as set forth in claim 29, wherein the adhesive rivet is formed by applying the adhesive while in its liquid state to the underside of the panel about the through-hole formed through the panel;
placing the bait station onto a substrate, whereupon a first portion of the still liquid adhesive flows onto the surface of the substrate and a second portion of the still-liquid adhesive flows through the through-hole in the panel;
pushing the panel onto the substrate to force at least some of the first portion of the still-liquid adhesive through the through-hole to form a mushroom-shaped head onto an interior surface of the panel and to force at least some of the second portion of the liquid adhesive to spread out onto the substrate to form a greater contact area between the underside of the panel and the surface of the substrate; and
upon curing of the adhesive, forming the adhesive rivet composed of some of the first portion of the adhesive that was forced through the through-hole to form the mushroom-shaped head on the inside surface of the panel and some of the second portion of the adhesive that was spread-out onto the surface of the substrate.

31. The adhesive rivet as set forth in claim 30, wherein the adhesive qualities of the adhesive also forms a seal with the through-hole 14H in the panel 14P.

32. The adhesive rivet as set forth in claim 30, wherein the adhesive comprises a high modulus adhesive for exterior bonding and forming.

33. The adhesive rivet as set forth in claim 30, wherein the adhesive comprises a thixotropic adhesive.

34. The adhesive rivet as set forth in claim 33, wherein the adhesive has a tensile strength exceeding about 4,000 psi, and at least about 40% elongation.

35. The adhesive rivet as set forth in claim 30, further comprising a form-cap positioned over the through-hole in the panel to control the thickness and girth of the mushroom-shaped head of the adhesive rivet that forms on the interior surface of the panel.

36. The adhesive rivet as set forth in claim 35, wherein the form-cap is vented to preclude an air-block that might otherwise impede the flow of the still-liquid adhesive therein during formation of the mushroom-shaped head.

37. The adhesive rivet as set forth in claim 35, wherein the form-cap comprises a semi-spherical configuration.

38. The adhesive rivet as set forth in claim 35, wherein the form-cap comprises a disk-shaped configuration.

39. The adhesive rivet as set forth in claim 35, wherein the form-cap comprises a triangular-shaped configuration.

40. The adhesive rivet as set forth in claim 35, wherein the form-cap comprises a rectangular-shaped configuration.

41. The adhesive rivet as set forth in claim 35, wherein the form-cap snap-fits into a retainer positioned about the through-hole.

42. The adhesive rivet as set forth in claim 35, wherein the form-cap is formed integrally about the through-hole of the panel

43. The adhesive rivet as set forth in claim 30, further comprising a perforated dome formed about the through-hole in the panel to initially begin defining the mushroom-shaped head of the adhesive rivet and to further increase the mechanical connection with the panel as the still-liquid adhesive flows through apertures in the dome onto the surface of the dome to form multiple mushroom-shaped heads thereon.

44. The adhesive rivet as set forth in claim 43, wherein the perforated dome is formed integrally about the through-hole.

45. The adhesive rivet as set forth in claim 35, further comprising a perforated dome formed about the through-hole in the panel to initially begin defining multiple mushroom-shaped heads of the adhesive rivet such that the still-liquid adhesive flows through apertures in the dome onto the surface of the dome to form multiple mushroom-shaped heads thereon.

46. The adhesive rivet as set forth in claim 45, wherein the subsequently-installed form-cap further defines the multiple mushroom-shaped heads on the surface of the dome.

47. The adhesive rivet as set forth in claim 45, wherein the form-cap includes a center retainer that snaps into one of the dome's apertures to hold the form-cap in position while the adhesive cures.

48. The adhesive rivet as set forth in claim 30, further including a rivet shaft to be positioned in a mounting hole to mechanically connect the adhesive rivet to the substrate.

49. The adhesive rivet as set forth in claim 29, wherein the through-hole comprises a circular-cylindrical configuration, a V-configuration or an inverted V-configuration.

50. The adhesive rivet as set forth in claim 29, wherein the through-hole comprises a preformed knock-out plug that may be knocked-out to form the through-hole.

51. A ballasted bait station comprising a locking chamber with a snap-shut, pivotable access door allowing a ballast of sufficient weight to assure immobilization, to be inserted therein to thereby eliminate the need to otherwise secure the bait station to a substrate.

52. The ballasted bait station as set forth in claim 51, further including at least one side ramp affixed a side panel of the chamber
